(19) United States
(12) Patent Application Publication
(10) Pub. No.: US 2026/0175763 A1
(43) Pub. Date: Jun. 25, 2026

(54) PACKAGING SYSTEM WITH PRELOADED CLAMPING AND CONVERTIBLE DOOR RAMP FOR TRANSPORTING EQUIPMENT

(71) Applicant: Aivres Systems Inc., Fremont, CA (US)

(72) Inventor: Yu-Hsien HUANG, New Taipei City (TW)

(21) Appl. No.: 19/538,949

(22) Filed: Feb. 12, 2026

(51) Int. Cl. B60P 1/43; B65D 19/44

(52) U.S. Cl. CPC B60P 1/431; B60P 1/43; B60P 1/433; B65D 19/44

(57) ABSTRACT

A packaging system for transporting equipment includes a base platform and a frame coupled to the base platform and configured to surround the equipment. Clamping assemblies mounted to the frame each include an elastomeric block and one or more fasteners configured, when tightened, to compress the elastomeric block to increase clearance for inserting or removing the equipment, and, when loosened, to allow the elastomeric block to expand toward a corresponding side surface of the equipment when the equipment is received in the frame. The frame further includes a panel assembly movable between a closed position covering an opening of the frame and a ramp position defining a ramp to guide movement of the equipment between the base platform and a floor surface, and a support stand assembly coupled to an inner side of the panel assembly to support the panel assembly in the ramp position.

### TECHNICAL FIELD

The disclosed subject matter relates generally to packaging and transport of equipment cabinets. More particularly, it relates to systems and structures for securing and handling fully or partially populated equipment cabinets, such as server racks or AI computing racks, during shipment and unloading.

### BACKGROUND

Equipment cabinets, such as server racks and AI computing racks, are commonly shipped from manufacturers or integrators to end customers. In traditional logistics arrangements, many suppliers ship at a relatively low level of integration, where individual machines and an empty rack are delivered separately and assembled at the customer site. In these cases the rack is comparatively light, and conventional wooden pallets and simple foam cushioning are often sufficient.

With the increasing use of high density computing solutions, customers increasingly request shipment of fully integrated racks. A fully populated equipment cabinet can weigh on the order of one ton or more when loaded with servers, networking equipment, power delivery and cooling components. Under such loading, packaging structures designed for lighter racks can be inadequate in terms of load bearing capacity, stability and ease of handling.

In common practice, equipment cabinets are mounted on wooden pallets or skids. For heavier racks, simply increasing wood thickness is constrained by forklift and pallet jack geometry. All-wood pallets may deform or crack under static and dynamic loads associated with a fully populated rack, and loss of flatness can lead to uneven support of the cabinet casters. This can increase the risk of tilt, vibration damage and local overstress. Some designs introduce foam or expanded polyethylene layers within the pallet. While such materials can cushion moderate loads, they tend to compress and creep under sustained heavy loading, so that they function more as gap fillers than as reliable structural supports.

Side protection for equipment cabinets is often implemented by inserting foam blocks or sheets between the cabinet and an outer frame or carton. These pieces are typically dimensioned to fill available gaps. Such approaches distribute contact forces but do not provide targeted restraint in regions where the cabinet's mass is concentrated, for example near its center of gravity at mid height. Under lateral shocks, the cabinet can still shift because the foam yields, and the upper portion of the cabinet may rock relative to the pallet.

Some packaging solutions may also use door panels that serve as ramps during unloading. In some implementations, a single full height door panel is folded down to form a ramp from the pallet to the floor. For tall wooden doors, this panel can be large and heavy, making safe handling difficult and often requiring multiple operators. In addition, ramp support elements such as triangular braces are sometimes mounted on the outer face of the door, where they protrude beyond the footprint of the pallet and frame. These external supports are prone to impact during transport, which can misalign or damage the ramp before use. When unloading a heavy cabinet, especially at sites without overhead cranes or similar lifting equipment, a damaged or unprotected ramp can present significant safety and reliability concerns.

The surface of conventional ramps is typically smooth. For heavy cabinets, once motion begins down such a ramp, the cabinet can accelerate quickly. Operators may need to apply substantial force to restrain the cabinet, increasing the risk of loss of control, tipping or collision. At the same time, handling environments vary. Some sites are equipped with overhead cranes that can lift cabinets directly from above, while others rely solely on pallet jacks or forklifts operating from the floor. Manual pallet jacks, in particular, require that their front wheels enter recesses under or at the edge of the pallet in order to lift the load effectively, which can conflict with lower blocking structures if not properly designed.

Accordingly, there is a need for packaging systems for equipment cabinets, particularly fully populated and heavy racks, that can support high loads with controlled deflection, provide targeted mechanical restraint at the lower and mid height regions of the cabinet, remain compatible with both electric and manual pallet jacks, and enable safer unloading by using door or panel structures that form controlled ramps with protected supports and movement-resisting features to reduce the risk of uncontrolled cabinet motion.

### SUMMARY

In one general aspect, a packaging system for transporting equipment includes a base platform configured to support the equipment, a frame coupled to the base platform and configured to surround the equipment, and a plurality of clamping assemblies mounted to the frame and configured to be positioned adjacent to side surfaces of the equipment. Each clamping assembly includes an elastomeric block configured to engage a corresponding side surface of the equipment, and one or more fasteners extending through the frame and configured, when tightened, to compress the elastomeric block to increase clearance for inserting or removing the equipment and, when loosened, to allow the elastomeric block to expand toward the corresponding side surface of the equipment when the equipment is received in the frame.

Implementations may include one or more of the following features. The elastomeric block includes a first side facing the frame at a mounting portion on which the clamping assembly is mounted and a second side facing away from the mounting portion of the frame, and each clamping assembly further includes a contact pad coupled to the second side of the elastomeric block, such that the elastomeric block is configured to engage the corresponding side of the equipment via the contact pad. Each clamping assembly is configurable to be in an installation state in which the one or more fasteners are tightened to compress the elastomeric block and pull the contact pad toward the mounting portion of the frame, increasing clearance for inserting or removing the equipment. Each clamping assembly is also configurable to be in a clamping state in which, after the equipment is in place, the one or more fasteners are loosened to reduce compression of the elastomeric block and allow the elastomeric block to expand and urge the contact pad into clamping engagement with the corresponding side surface of the equipment. The frame and the plurality of clamping assemblies together define a lower restraint region fixed relative to the base platform and positioned to engage a lower portion of the equipment to limit lateral movement of the lower portion of the equipment, and the lower restraint region further includes at least two lower restraint beams fixed relative to the base platform and disposed on an inner side of the frame. The packaging system further includes an intermediate restraint region fixed relative to the frame at a height corresponding to a center of gravity region of the equipment and positioned to engage the equipment at the height to limit rocking or tipping of the equipment relative to the base platform. The intermediate restraint region includes at least one elongated restraint beam disposed on an inner side of the frame and extending along at least one side of the frame at the height above the base platform, and the at least one elongated restraint beam is fastened to the frame by a plurality of brackets. The plurality of clamping assemblies includes at least two clamping assemblies, including at least one clamping assembly mounted on a first side portion of the frame and at least one clamping assembly mounted on an opposing second side portion of the frame. The base platform includes a lower layer, a lower metal plate disposed above the lower layer, a plurality of elastomeric support blocks disposed above the lower metal plate, an upper metal plate disposed above the plurality of elastomeric support blocks, and an upper layer disposed above the upper metal plate.

In one general aspect, a packaging system for transporting equipment includes a base platform and a frame coupled to the base platform and configured to surround the equipment. The frame includes a panel assembly movable between a closed position, in which the panel assembly is positioned to cover an opening of the frame, and a ramp position, in which at least a portion of the panel assembly defines a ramp configured to guide movement of the equipment between the base platform and a floor surface. The panel assembly includes an inner side facing toward the equipment and an outer side facing away from the equipment. The packaging system further includes a support stand assembly coupled to the inner side of the panel assembly and configured to support the panel assembly when defining the ramp.

Implementations may include one or more of the following features. When the panel assembly is in the ramp position, the panel assembly is configured to be at an inclined orientation relative to the floor surface and supported by the support stand assembly. The outer side of the panel assembly includes a ramp surface, and the ramp surface includes movement-resisting features configured to resist movement of the equipment along the ramp surface. The movement-resisting features include a plurality of transverse ribs extending across the ramp surface between raised side edges. The panel assembly includes a lower door panel and an upper door panel, and, in the closed position, the lower door panel and the upper door panel together form a continuous side wall of the frame. Each of the lower door panel and the upper door panel includes at least one handle accessible from outside the frame in the closed position to facilitate manual handling of the respective door panel. The packaging system includes at least one latch configured to releasably secure the panel assembly to the frame in the closed position. The support stand assembly includes at least one support stand having a generally triangular profile in a side view, the at least one support stand having a first side fixed to the inner side of the panel assembly and a second side configured to rest on the floor surface when the panel assembly is in the ramp position. The ramp surface further includes raised side edges extending along opposite lateral sides of the ramp surface and configured to guide the movement of the equipment along the ramp surface.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1A illustrates an example packaging arrangement including a base platform, a frame and a separate ramp used to move an equipment cabinet off the base platform.

FIG. 1B illustrates a door panel with ramp support beams mounted on an outer surface of the door panel.

FIG. 2 illustrates an exploded view of a base platform having upper and lower wooden layers, upper and lower metal plates, elastomeric support blocks and edge recesses.

FIG. 3A illustrates a packaging system including a base platform, a surrounding frame, a side panel assembly, preloaded clamping assemblies and a door panel assembly mounted to the frame, in accordance with some embodiments.

FIG. 3B illustrates the packaging system of FIG. 3A with a support stand assembly positioned on an inner side of the door panel assembly within the frame, in accordance with some embodiments.

FIG. 3C illustrates the packaging system of FIG. 3A with the door panel assembly deployed as a ramp and the support stand assembly supporting the door panel assembly at an inclined orientation, in accordance with some embodiments.

FIG. 4A illustrates an arrangement of preloaded clamping assemblies around an equipment cabinet footprint, including adjustment fasteners, elastomeric blocks and contact pads, in accordance with some embodiments.

FIG. 4B illustrates different operating states of a clamping assembly, including an uncompressed state, an installation state with compressed elastomeric block and increased clearance, and a clamping state in which the elastomeric block urges the contact pad against the cabinet, in accordance with some embodiments.

FIG. 4C illustrates thick wooden lower restraint beams on the base platform that limit movement of a lower portion of the equipment cabinet, in accordance with some embodiments.

FIG. 5 illustrates thick wooden intermediate restraint beams at mid-height of the frame, together with upper cushioning material, to limit cabinet movement near a center-of-gravity region, in accordance with some embodiments.

FIG. 6 illustrates an example method of using the packaging system with preloaded clamping and convertible door ramp to move the equipment cabinet between the base platform and a floor surface, in accordance with some embodiments.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

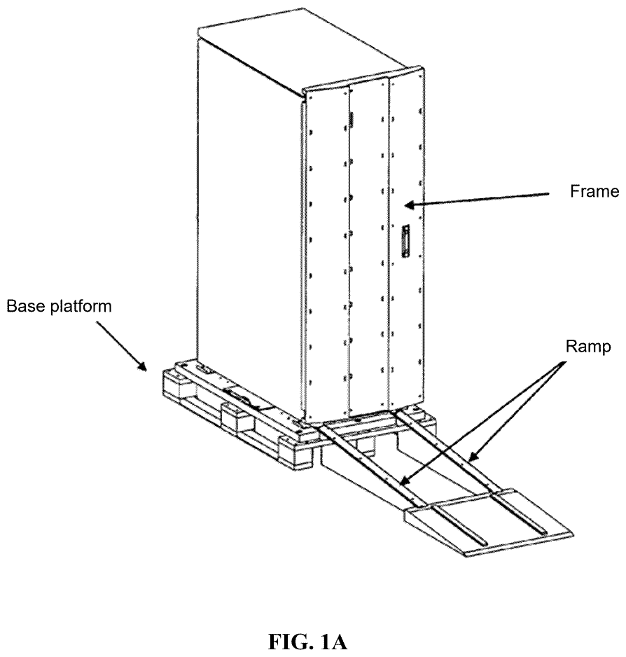

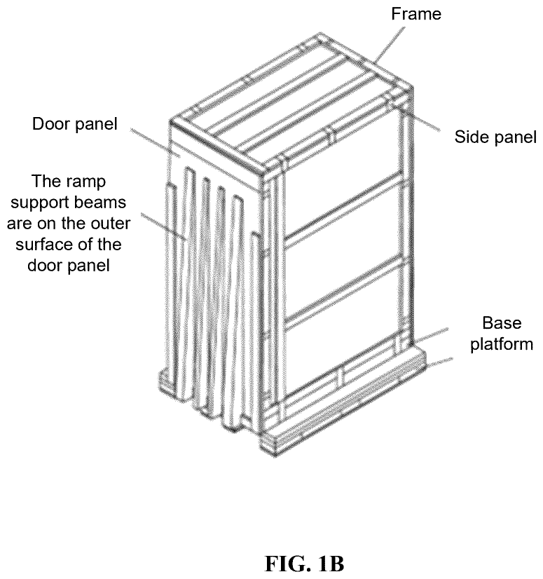

FIG. 1A illustrates an arrangement in which an equipment cabinet is supported on a base platform and is enclosed by a frame, and a separate ramp is positioned adjacent the base platform to allow the equipment cabinet to be moved off the base platform. In this configuration, the base platform is typically constrained in thickness and geometry to remain compatible with material-handling equipment, and a base platform formed primarily of wood may be inadequate for transporting a fully populated equipment cabinet having a total weight on the order of one ton or more. Under such heavy loading and transport shock, the base platform may deform, lose flatness, or suffer damage, which can lead to uneven support of the equipment cabinet and increased transmission of vibration and impact to internal precision electronic components. Some related approaches attempt to add foam layers within the base platform for vibration reduction, but such foam layers may be overly compressible at one ton or more, resulting in excessive compression, loss of the designed height, and a tendency for the base platform to tilt when the center of gravity changes during movement. FIG. 1A further reflects that unloading relies on the ramp and operator control; when a heavy equipment cabinet is moved along the ramp without inherent guidance and movement resistance, the equipment cabinet can accelerate or deviate laterally, and the risk of tipping increases because the center of gravity is typically located at a mid-height region of the equipment cabinet.

FIG. 1B illustrates an arrangement in which a frame is mounted on a base platform, with a side panel and a door panel forming part of an enclosure. The door panel is configured to be deployed as a ramp, and the ramp support beams are on the outer surface of the door panel. Because the ramp support beams are exposed on the outer surface, they are susceptible to collision and damage during handling and transport, including impacts that can deform or misalign the ramp support beams and compromise the ramp function. In addition, the use of the door panel as a ramp in this arrangement still presents challenges for moving a heavy equipment cabinet in a controlled manner when overhead lifting equipment is unavailable or space is limited, since the cabinet's mass and center-of-gravity height can make it difficult for operators to control speed and direction during unloading, and uncontrolled movement can lead to tipping, equipment damage, and injury.

Accordingly, this disclosure is directed to addressing difficulties encountered in transporting an equipment cabinet using a packaging system, including that a base platform formed solely of wood may be insufficient to support an equipment cabinet (e.g., with a weight exceeding one ton), that the overall packaging should provide enhanced vibration reduction and impact resistance for such heavy transport, and that the movement of the equipment cabinet during unpacking and placement should incorporate protective and specially configured features to reduce the risk of uncontrolled motion and tipping.

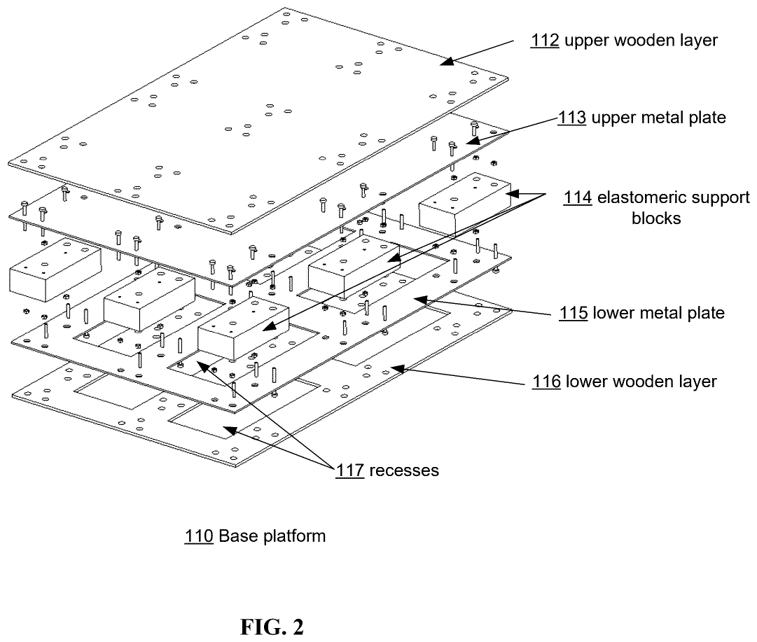

FIG. 2 illustrates an exploded view of an example base platform 110, in accordance with some embodiments. In this example, the base platform 110 includes a lower wooden layer 116, a lower metal plate 115 disposed above the lower wooden layer 116, a plurality of elastomeric support blocks 114 disposed above the lower metal plate 115, an upper metal plate 113 disposed above the plurality of elastomeric support blocks 114, and an upper wooden layer 112 disposed above the upper metal plate 113.

This layered construction differs from pallets that rely primarily on wood as the principal load-carrying structure, and also differs from designs that use foam materials such as expanded polyethylene (EPE) as an internal filler or spacer for vibration reduction. In conventional all-wood designs, the wood layers are required to carry both bending and compressive loads, and the thickness of the wood layers is practically constrained by compatibility with forklifts and pallet jacks, such that the pallet can be susceptible to deflection, loss of flatness, or cracking under the static and dynamic loads associated with transporting a fully populated equipment cabinet having a weight on the order of one ton or more. In foam-core designs, the foam layer can be overly compressible at such weights, which can lead to excessive compression, loss of designed height, and tilt when the center of gravity changes during movement, and the foam material may also be prone to damage and performance variation due to impact and temperature.

In the illustrated base platform 110, the lower metal plate 115 and the upper metal plate 113 cooperate to provide structural strength and to maintain planarity of the base platform 110 under heavy loading. For example, in some embodiments, the lower metal plate 115 and the upper metal plate 113 act as primary load-spreading members that resist bending and distribute cabinet loads over a larger area of the base platform 110, thereby reducing localized deformation that could otherwise cause uneven support of the cabinet. The elastomeric support blocks 114 are arranged between the upper metal plate 113 and the lower metal plate 115 and provide compliant support that absorbs vibration and shock while remaining suitable for high load applications. For example, in some embodiments, the elastomeric support blocks 114 comprise rubber blocks selected to provide a cushion-like compressive response that reduces transmission of impact and vibration from the base platform 110 into the equipment cabinet while avoiding the excessive creep and softness associated with EPE-based fillers. In this manner, the elastomeric support blocks 114 serve as dedicated vibration-damping and buffering elements rather than merely filling space, and the combination of the metal plates 113, 115 with the elastomeric support blocks 114 enables the base platform 110 to maintain a target height and flatness during transport and during movement of the loaded cabinet.

The upper wooden layer 112 and the lower wooden layer 116 provide surfaces that can tolerate contact, abrasion, and incidental impacts during handling, while preserving the structural performance provided by the metal plates 113, 115. For example, in some embodiments, the upper wooden layer 112 functions as a wear layer that protects the upper metal plate 113 from direct contact with the equipment cabinet, fasteners, or handling tools, and the lower wooden layer 116 functions as a sacrificial layer that can receive dents or scratches from forklift forks, pallet jack components, or floor contact. By using wood layers primarily as wear and interface layers, rather than as the principal bending members, the base platform 110 can achieve improved durability and serviceability while still meeting handling constraints associated with standard material-handling equipment.

FIG. 2 further illustrates one or more recesses 117 formed on the lower layers of the base platform 110. The recesses 117 are configured to receive wheels of a pallet jack to facilitate lifting the base platform 110 and the equipment cabinet. This feature addresses practical handling constraints associated with manual pallet jacks, which may require the front wheels to enter a recessed region in order to position the jack and lift the load without prying or excessive leverage. For example, in some embodiments, the recesses 117 provide clearance for the front wheels of a manual pallet jack such that the jack arms can be inserted under the base platform 110 and raised in a stable manner, while the metal plates 113, 115 and elastomeric support blocks 114 continue to provide the primary structural load path.

The number, size, shape, and placement of elastomeric support blocks 114 can be selected based on load requirements, cabinet footprint, desired stiffness and damping characteristics, and compatibility with handling equipment. The illustrated arrangement of elastomeric support blocks 114 in FIG. 2 is an example configuration, and is not intended to limit the present disclosure. For example, in some embodiments, the base platform 110 can include more or fewer elastomeric support blocks 114, and the elastomeric support blocks 114 can be distributed in a pattern corresponding to expected load concentration regions of the equipment cabinet, while still providing a layered sandwich structure comprising the wooden layers 112, 116, the metal plates 113, 115, and the elastomeric support blocks 114 disposed therebetween.

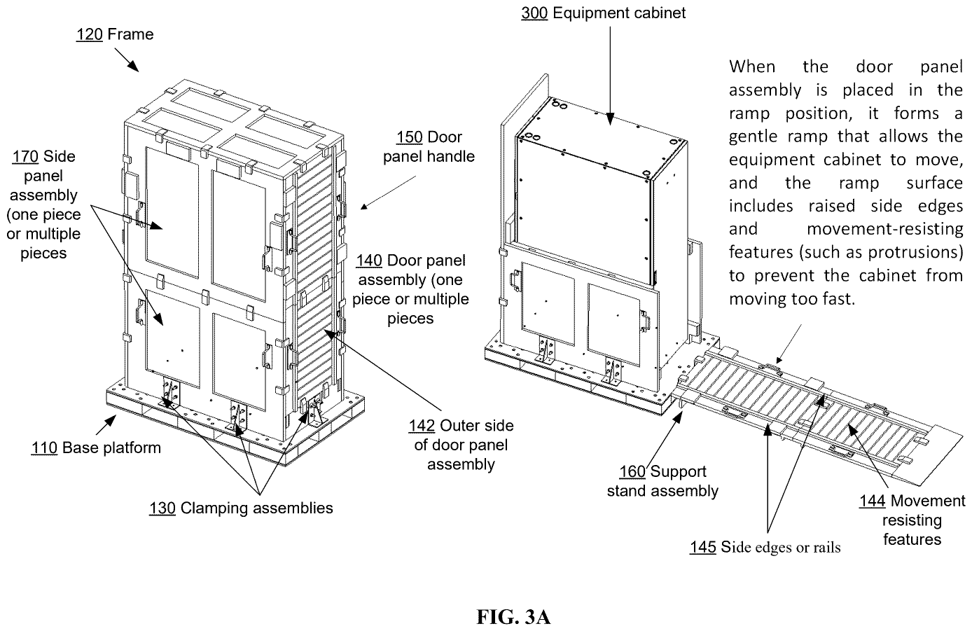

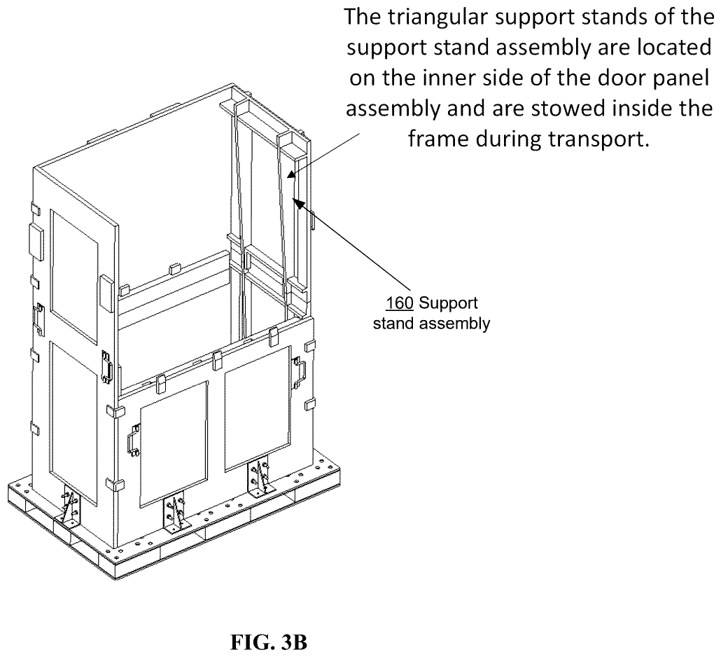

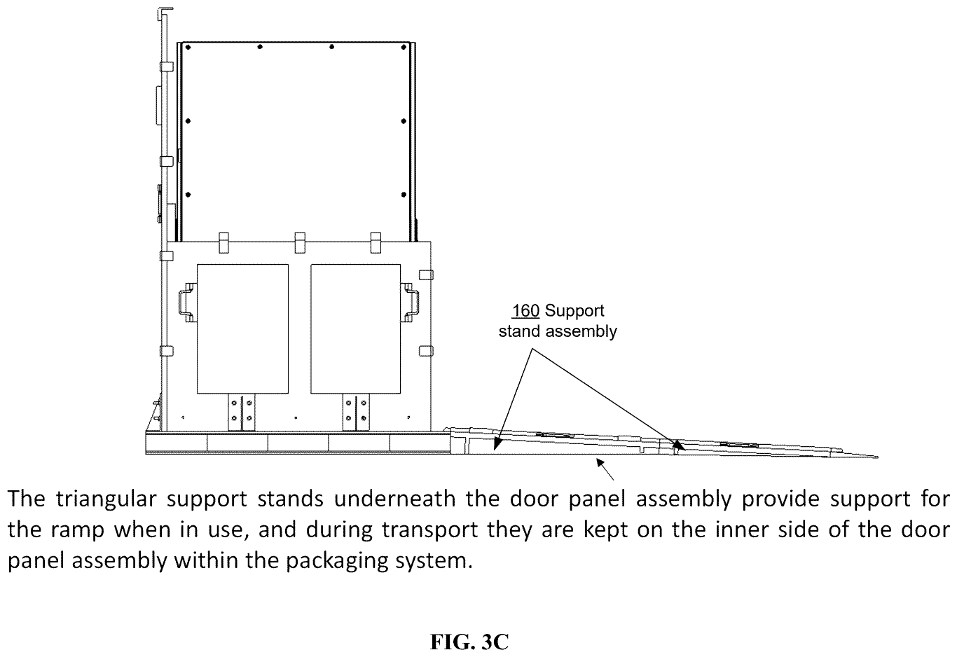

FIG. 3A illustrates an example packaging system for transporting an equipment cabinet 300, in accordance with some embodiments. The packaging system includes a base platform 110 configured to support the equipment cabinet 300 on a floor surface, and a frame 120 coupled to the base platform 110 and configured to surround the equipment cabinet 300. The base platform 110 can be implemented using the sandwich construction described with respect to FIG. 2, such that the base platform 110 provides improved load-bearing capacity and planarity for heavy, fully populated equipment cabinets while also providing vibration reduction and impact buffering. The frame 120 extends upward from the base platform 110 and defines a surrounding enclosure that cooperates with additional packaging components to restrain movement of the equipment cabinet 300 during transport.

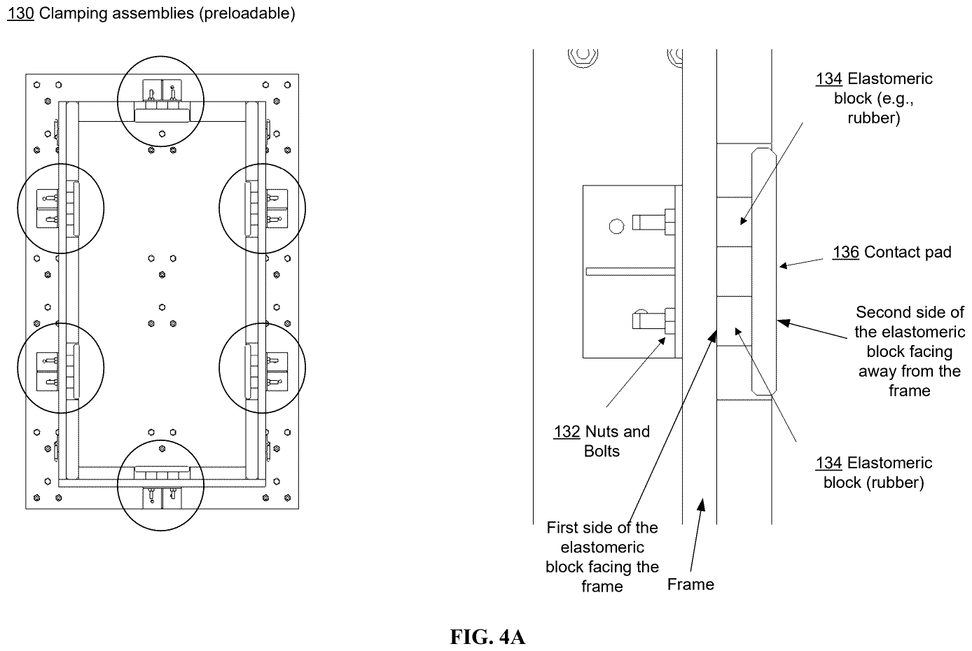

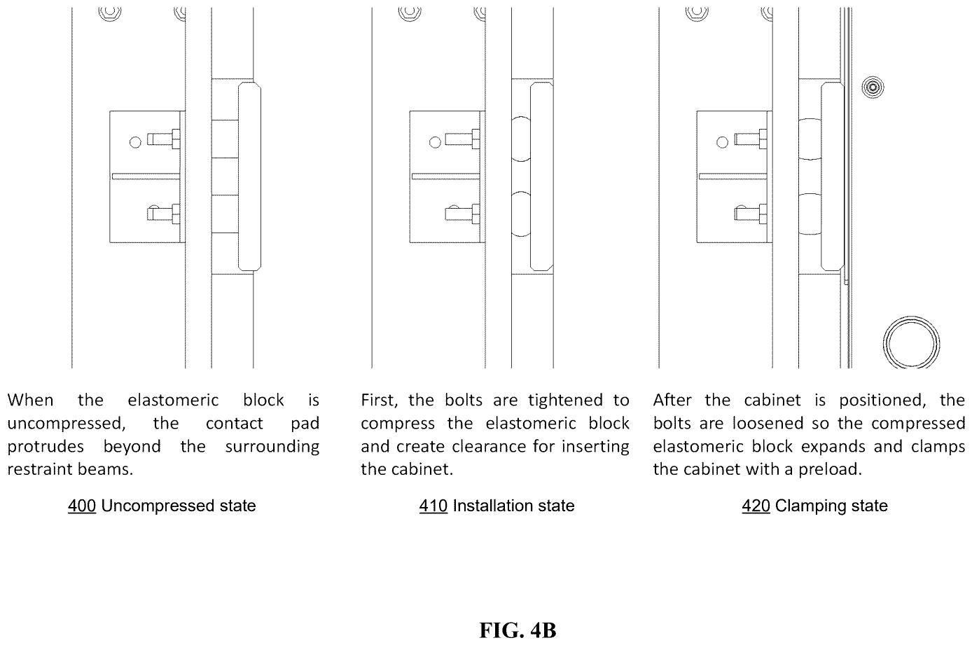

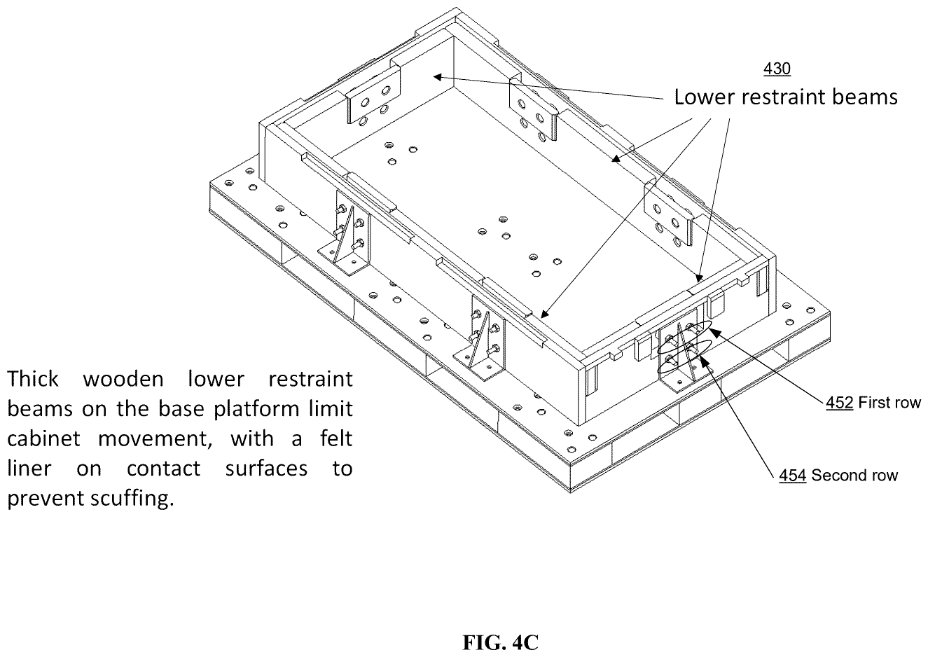

As shown in FIG. 3A, the packaging system further includes a plurality of clamping assemblies 130 mounted to the frame 120, and positioned adjacent side surfaces of the equipment cabinet 300. In some embodiments, the clamping assemblies 130 are mounted to the frame 120 via one or more brackets that may be coupled to the base platform 110. The clamping assemblies 130 can be distributed around multiple sides of the frame 120 and can be configured to apply preloaded side clamping forces against the equipment cabinet 300, thereby limiting lateral shifting and vibration during transport. In some embodiments, each clamping assembly 130 includes an elastomeric block, a contact pad, and one or more adjustment fasteners, as described in further detail with respect to FIGS. 4A-4C, such that the clamping assembly 130 is configurable between an installation state that provides increased clearance for inserting or removing the equipment cabinet 300 and a clamping state in which the elastomeric block expands to urge the contact pad into clamping engagement with a corresponding side surface of the equipment cabinet 300.

FIG. 3A further illustrates that the packaging system includes a door panel assembly 140 mounted to a side portion of the frame 120. In the illustrated embodiment, the door panel assembly 140 forms at least part of a side wall of the frame 120 when installed in a closed position. The door panel assembly 140 has an inner side that faces toward the equipment cabinet 300 when the door panel assembly 140 is in the closed position, and an outer side 142 that faces away from the equipment cabinet 300 when the door panel assembly 140 is in the closed position. In some embodiments, the door panel assembly 140 is removably secured to the frame 120 by one or more latches or other releasable fastening structures such that the door panel assembly 140 can be detached from the frame 120 for unloading operations. In some embodiments, the door panel assembly 140 comprises one piece, while in other embodiments the door panel assembly 140 comprises multiple pieces. For example, in some embodiments, the door panel assembly 140 includes a lower door panel and an upper door panel that, in the closed position, together form a continuous side wall of the frame 120, thereby reducing the weight of each panel and allowing a single operator to handle the panels more safely during installation and removal. In some embodiments, one or more handles 150 are provided on the door panel assembly 140, for example on each of the lower door panel and the upper door panel, such that the handle 150 is accessible from outside the frame 120 when the door panel assembly 140 is in the closed position to facilitate manual handling of the respective panel.

FIG. 3A also illustrates a side panel assembly 170 mounted to one or more sides of the frame 120. In some embodiments, the side panel assembly 170 is provided on three sides of the frame 120 other than the side corresponding to the door panel assembly 140. The side panel assembly 170 can be configured as one piece or as multiple pieces. In embodiments in which the side panel assembly 170 comprises multiple pieces, adjacent pieces can be removably coupled to each other and/or to the frame 120. For example, in some embodiments, each piece is secured to the frame 120 by one or more mechanical fasteners (e.g., bolts, screws, or pins), and/or by one or more latches or quick-release couplers, such that a selected piece can be released and removed without disassembling the frame 120. In some embodiments, one or more mating features (e.g., overlap flanges, tongues-and-grooves, or alignment pins) are provided along adjoining edges to maintain relative alignment between pieces when installed. For example, in some embodiments, configuring the side panel assembly 170 as multiple pieces allows selected panels to be removed to visually monitor or access the equipment cabinet 300 during loading and unloading, and also reduces the weight of individual panels for easier handling. In some embodiments, the side panel assembly 170 can include transparent or openable portions, or can include removable sections positioned to provide access to areas where straps, clamps, or inspection operations are performed, while still enclosing the equipment cabinet 300 during transport.

FIGS. 3A-3C further illustrate that the door panel assembly 140 is not only a side wall of the packaging system in the closed position, but is also configured to be moved into a ramp position for unloading. In the ramp position, at least part of the door panel assembly 140 extends downward from the base platform 110 toward the floor surface to define a ramp configured to guide movement of the equipment cabinet 300 between the base platform 110 and the floor surface. In some embodiments, the door panel assembly 140 is first detached from the frame 120 and removed from the closed position, for example by an operator grasping the handle 150, and the door panel assembly 140 is then repositioned relative to the base platform 110 to form the ramp. In some embodiments, the door panel assembly 140 is positioned such that one edge of the door panel assembly 140 is supported by or abutting the base platform 110 and an opposite remote edge of the door panel assembly 140 rests on the floor surface, thereby defining an inclined ramp surface. In the ramp position, the outer side 142 of the door panel assembly 140 in the closed position is oriented upward and defines a ramp surface along which the equipment cabinet 300 can roll or slide.

FIG. 3A further illustrates movement-resisting features 144 disposed on the ramp surface of the door panel assembly 140. In some embodiments, the movement-resisting features 144 are arranged along a length of the ramp surface extending from an edge adjacent the base platform 110 toward a remote edge of the door panel assembly 140. The movement-resisting features 144 are configured to resist movement of the equipment cabinet 300 along the ramp surface, thereby reducing the tendency of a heavy equipment cabinet 300 to accelerate uncontrollably when moving downward from the base platform 110 to the floor surface. For example, in some embodiments, the movement-resisting features 144 include a plurality of transverse ribs extending across the ramp surface, and the transverse ribs can be spaced apart along the ramp length such that the equipment cabinet 300 experiences stepwise resistance as it traverses the ribs. In some embodiments, the transverse ribs extend across the ramp surface between the raised side edges. In some embodiments, the ramp surface further includes raised side edges or rails 145 extending along opposite lateral sides of the ramp surface, and the raised side edges or rails 145 cooperate with the movement-resisting features 144 to guide movement of the equipment cabinet 300 along a desired path and reduce lateral drift during unloading.

FIG. 3B illustrates the packaging system with a support stand assembly 160 associated with the door panel assembly 140, in accordance with some embodiments. The support stand assembly 160 is attached to the inner side of the door panel assembly 140 when the door panel assembly 140 is in the closed position. In this configuration, the support stand assembly 160 is located within the enclosure of the frame 120, such that components of the support stand assembly 160 are stowed inside the packaging system during transport. This arrangement differs from the embodiments in which ramp support structures protrude outward from an outer surface of the door panel. By locating the support stand assembly 160 on the inner side of the door panel assembly 140, the support stand assembly 160 is less susceptible to impact or collision during transport and handling, and the outer side 142 of the door panel assembly 140 can remain relatively flush to reduce interference with adjacent cargo or personnel.

FIG. 3C illustrates the door panel assembly 140 deployed in the ramp position with the support stand assembly 160 supporting the door panel assembly 140 at an inclined orientation relative to the floor surface, in accordance with some embodiments. When the door panel assembly 140 is in the ramp position, the support stand assembly 160 is moved from its stowed configuration on the inner side of the door panel assembly 140 to a supporting configuration in which one or more support stands contact the floor surface and provide load-bearing support under the door panel assembly 140. In some embodiments, the support stand assembly 160 comprises at least one support stand having a generally triangular profile in a side view. Each such support stand can have a first side fixed to the inner side of the door panel assembly 140 and a second side configured to rest on the floor surface when the door panel assembly 140 is in the ramp position, thereby forming a stable triangular support geometry that resists bending or collapse of the door panel assembly 140 under the weight of the equipment cabinet 300 as it moves along the ramp surface.

As shown in FIG. 3C, the support stand assembly 160 can include multiple triangular (or trapezoidal) support stands distributed along a width of the door panel assembly 140 to provide distributed support and to maintain a desired incline angle of the ramp. The number and placement of the triangular support stands can be selected based on factors such as the expected cabinet weight, the width of the door panel assembly 140, and the desired maximum deflection of the ramp during unloading. The illustrated arrangement of the support stand assembly 160 is an example and does not limit the present disclosure. For example, in some embodiments, the support stand assembly 160 includes more or fewer support stands, and the support stands can be reinforced with cross members or gussets to meet higher load requirements while remaining attached to the inner side of the door panel assembly 140 in the closed position so that the support stands remain protected within the packaging system during transport.

In operation, the packaging system of FIGS. 3A-3C enables transport of a heavy equipment cabinet 300 while providing a controlled unloading mechanism. The base platform 110 provides a stable support surface with improved load-bearing and vibration damping characteristics. The frame 120 and side panel assembly 170 enclose the equipment cabinet 300, while the clamping assemblies 130 apply preloaded restraint to reduce lateral movement and vibration during transport. Upon arrival, the door panel assembly 140 can be released from the frame 120, removed using handle 150, and repositioned to form a ramp extending from the base platform 110 to the floor surface, with the outer side 142 of the door panel assembly 140 facing upward to define the ramp surface. The support stand assembly 160, which was previously stowed on the inner side of the door panel assembly 140 within the frame 120, is then deployed to support the door panel assembly 140 at the inclined orientation. The movement-resisting features 144 and any raised side edges on the ramp surface cooperate to resist rapid cabinet movement and guide the cabinet path, thereby reducing the risk of uncontrolled acceleration, lateral drift, and tipping during unloading of a heavy equipment cabinet 300.

FIG. 4A illustrates an example arrangement of preloaded clamping assemblies 130 disposed around a footprint region in which an equipment cabinet is received, in accordance with some embodiments. In the illustrated embodiment, the clamping assemblies 130 are mounted to a frame that surrounds the equipment cabinet and are positioned adjacent respective side surfaces of the equipment cabinet when the equipment cabinet is seated on a base platform (e.g., 110 in FIG. 2 and FIG. 3A). Each clamping assembly 130 includes one or more adjustment fasteners, illustrated as nuts and bolts 132, that extend through a portion of the frame and cooperate with an elastomeric block 134 and a contact pad 136, configured to apply a controlled clamping force against the equipment cabinet. The illustrated distribution of clamping assemblies 130 around the footprint region is an example and is not limiting. For example, in some embodiments, at least four clamping assemblies 130 are provided, and the at least four clamping assemblies 130 can be distributed such that at least two clamping assemblies 130 are mounted on a first side portion of the frame and at least two clamping assemblies 130 are mounted on an opposing second side portion of the frame. In some embodiments, at least four clamping assemblies 130 are respectively mounted to four different side portions of the frame such that each of the four side portions carries a single clamping assembly 130. More generally, the number and placement of clamping assemblies 130 can be selected based on cabinet mass, expected transport shock profile, desired restraint stiffness, and clearance requirements for loading and unloading, while still providing clamping forces at multiple side surfaces to reduce lateral movement and vibration of the equipment cabinet relative to the frame during transport.

As shown in the enlarged cross-sectional view (also a top view) of FIG. 4A, each clamping assembly 130 includes an elastomeric block 134 and a contact pad 136 arranged between the frame and the equipment cabinet. The elastomeric block 134 has a first side facing the frame and a second side facing away from the frame. The contact pad 136 is coupled to the second side of the elastomeric block 134 and is configured to engage a corresponding side surface of the equipment cabinet. In some embodiments, the elastomeric block 134 comprises elastomeric material, for example natural rubber, synthetic rubber (e.g., EPDM, nitrile rubber, silicone rubber, or neoprene), polyurethane elastomer, thermoplastic elastomer (TPE), or a layered/stacked combination of such materials, selected to provide a desired compressive compliance and damping response. In some embodiments, the contact pad 136 comprises a rigid or semi-rigid pad, for example a metal plate, a polymer plate, or a laminated structure, that distributes contact force over a larger area of the equipment cabinet side surface to reduce localized stress or surface damage. The nuts and bolts 132 serve as adjustment fasteners and extend through the frame such that tightening the nuts and bolts 132 draws the contact pad 136 toward the frame and thereby compresses the elastomeric block 134 between the contact pad 136 and the frame (thus creating more clearance for installing the equipment cabinet), and loosening the nuts and bolts 132 reduces the compression of the elastomeric block 134 to allow the elastomeric block 134 to expand (thus applying the compression force against the installed equipment cabinet). In this manner, the clamping assembly 130 provides a controllable preload mechanism in which compression of the elastomeric block 134 is adjusted by the nuts and bolts 132, and the resulting elastic restoring force of the elastomeric block 134 urges the contact pad 136 toward the equipment cabinet to provide clamping engagement.

FIG. 4B illustrates different operating states of an example clamping assembly 130, in accordance with some embodiments. FIG. 4B includes an uncompressed state 400, an installation state 410, and a clamping state 420. In the uncompressed state 400, the elastomeric block 134 is not significantly compressed, and the contact pad 136 protrudes inward beyond surrounding restraint structures, such that the contact pad 136 would contact or interfere with the equipment cabinet if the cabinet were inserted into the frame in this state. In the installation state 410, the nuts and bolts 132 are tightened to compress the elastomeric block 134 and to pull the contact pad 136 toward the frame. Tightening the nuts and bolts 132 in this manner increases a clearance between the contact pad 136 and the region where the equipment cabinet is received, thereby facilitating insertion or removal of the equipment cabinet without requiring the operator to force the cabinet past protruding pads. In the clamping state 420, after the equipment cabinet is positioned on the base platform within the frame, the nuts and bolts 132 are loosened to reduce compression of the elastomeric block 134. When the compression is reduced, the elastomeric block 134 expands and urges the contact pad 136 into clamping engagement with the corresponding side surface of the equipment cabinet, thereby restraining lateral movement of the equipment cabinet relative to the frame. In some embodiments, the nuts and bolts 132 are loosened to a controlled extent such that the elastomeric block 134 remains partially compressed, and the elastomeric block 134 thereby provides a sustained preload that maintains contact pressure between the contact pad 136 and the equipment cabinet even when the packaging system experiences vibration, thermal variation, or impact loading during transport. In some embodiments, the clamping state 420 is configured such that the contact pad 136 applies sufficient force to prevent relative sliding between the equipment cabinet and the frame under expected lateral shock, while still allowing limited compliance via the elastomeric block 134 to absorb vibration and reduce peak impact forces transmitted to the equipment cabinet.

FIG. 4C illustrates a lower restraint region associated with the base platform and the frame, in accordance with some embodiments. In the illustrated embodiment, thick wooden lower restraint beams 430 are disposed on an inner side of the frame and are fixed relative to the base platform such that the lower restraint beams 430 extend along at least two adjacent sides of the base platform around a lower portion of the equipment cabinet. When the equipment cabinet is seated on the base platform within the frame, the lower restraint beams 430 engage or closely surround a lower portion of the equipment cabinet, for example near the caster region or the lower cabinet perimeter, to limit movement of the lower portion of the equipment cabinet in at least one horizontal direction. In some embodiments, the lower restraint region is defined by the frame and at least some of the clamping assemblies 130 in combination with the lower restraint beams 430, and is fixed relative to the base platform.

In some embodiments, this lower restraint provided by the lower restraint beams 430 can cooperate with the clamping assemblies 130 described above, such that the lower restraint beams 430 provide positional blocking at a lower portion of the equipment cabinet while the clamping assemblies 130 provide an adjustable lateral restraint force against corresponding side surfaces of the equipment cabinet, thereby reducing the tendency of the equipment cabinet to “walk” or shift on the base platform during transport shocks. In some embodiments, the lower restraint beams 430 define a cabinet-receiving pocket at the base, and the contact pad 136 of each clamping assembly 130 is positioned relative to an inner surface of the lower restraint beams 430 based on the operating state of the clamping assembly 130. For example, when the clamping assembly 130 is in the installation state 410 (FIG. 4B), the one or more adjustment fasteners (e.g., nuts and bolts 132) are tightened to compress the elastomeric block 134 and draw the contact pad 136 toward the frame, such that the contact pad 136 is aligned with the inner surface of the lower restraint beams 430 or is retracted relative to the inner surface of the lower restraint beams 430, thereby increasing clearance for inserting or removing the equipment cabinet without interference from the contact pad 136. After the equipment cabinet is positioned, the clamping assembly 130 is switched to the clamping state 420 (FIG. 4B) by loosening the one or more adjustment fasteners to reduce compression of the elastomeric block 134, allowing the elastomeric block 134 to expand and urge the contact pad 136 toward the equipment cabinet. In this clamping state 420, the contact pad 136 can move forward and protrude beyond the inner surface of the lower restraint beams 430 so as to press against the corresponding side surface of the equipment cabinet, thereby applying a preloaded clamping force that complements the positional blocking provided by the lower restraint beams 430 at the base.

In some embodiments, the lower restraint beams 430 include a liner on surfaces facing the equipment cabinet. For example, in some embodiments, a felt liner is applied on contact surfaces of the lower restraint beams 430 to prevent scuffing, scratching, or abrasion of the equipment cabinet's exterior finish while still enabling the lower restraint beams 430 to function as rigid restraint structures. In some embodiments, the lower restraint beams 430 comprise wood to provide a robust, machinable restraint structure that can be replaced as a wear component, and the liner comprises wool felt or another soft protective material adhered or fastened to the beam surfaces that contact the equipment cabinet.

FIG. 4C also illustrates structural details of the clamping assembly mounting arrangement relative to the frame. In the illustrated embodiment, the clamping assembly 130 is mounted to a bracket structure that includes an L-shaped plate and one or more triangular support elements that reinforce the bracket against bending under clamping loads. In some embodiments, two rows of nuts and bolts 132 are used to provide distinct functions. In the example illustrated in FIG. 4C, a first row 452 of nuts and bolts provides the clamping adjustment function, and a second row 454 of nuts and bolts provides a fixed anchoring function. The first row 452 of nuts and bolts is coupled to the contact pad 136 such that tightening and loosening the nuts and bolts in the first row 452 varies compression of the elastomeric block 134 and thereby switches the clamping assembly 130 between the installation state 410 and the clamping state 420 described with respect to FIG. 4B. The second row 454 of nuts and bolts is fixed to a rigid mounting region of the frame, for example a reinforced base portion of the frame or a frame mounting bracket, to stabilize the L-shaped plate and to maintain the geometry of the clamping assembly 130 during operation. In this arrangement, the second row 454 of nuts and bolts functions as an anchor that resists rotation or translation of the bracket under load, while the first row 452 of nuts and bolts provides the adjustable degree of freedom that compresses and releases the elastomeric block 134 for clamping. This separation of functions increases stability of the mounting structure and reduces the likelihood that the frame will deform under preload forces generated by the elastomeric block 134, while still enabling rapid clearance adjustment for loading and sustained preloaded clamping during transport.

Accordingly, FIGS. 4A-4C illustrate how the packaging system achieves controlled, preload-based side clamping and targeted mechanical restraint. The clamping assemblies 130 provide a two-mode operational sequence that simplifies insertion of the equipment cabinet while enabling spring-like clamping engagement during transport, and the lower restraint beams 430 provide rigid positional blocking at the cabinet base, with optional protective liners to prevent cabinet surface damage. Together, these features reduce lateral movement, vibration, and rocking tendencies of heavy equipment cabinets during shipping and handling while remaining compatible with practical loading and unloading operations.

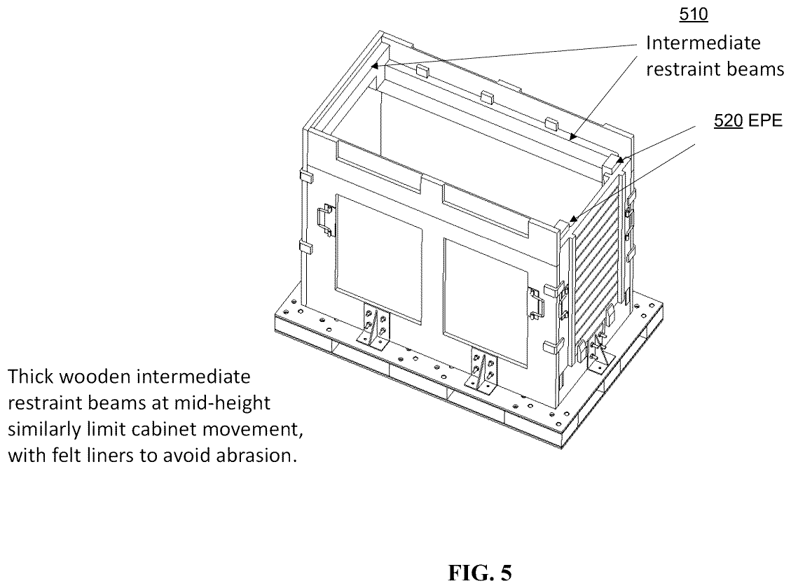

FIG. 5 illustrates an example intermediate restraint region implemented at a mid-height of the frame, in accordance with some embodiments. In the illustrated embodiment, one or more intermediate restraint beams 510 are disposed on an inner side of the frame and extend along a side portion of the frame at a height above the base platform that corresponds to a center-of-gravity region of the equipment cabinet when the equipment cabinet is installed in the packaging system. The intermediate restraint beams 510 are configured to engage, or to be positioned closely adjacent to, the equipment cabinet at the mid-height region such that the intermediate restraint beams 510 limit cabinet motion at the center-of-gravity region during transport, including motion modes that are not sufficiently controlled by lower restraint structures alone. For example, when a heavy equipment cabinet experiences lateral shocks, a lower restraint region may limit translation at the base, but the mass concentrated at mid-height can still induce rocking or tipping tendencies; the intermediate restraint beams 510 provide a complementary restraint point at mid-height to reduce such rocking or tipping tendencies relative to the base platform.

In some embodiments, the intermediate restraint beams 510 are elongated beams comprising wood and are fastened to the frame by a plurality of brackets, such that the intermediate restraint beams 510 provide a rigid mechanical stop aligned with the equipment cabinet's center-of-gravity region. In some embodiments, the intermediate restraint beams 510 include liners on cabinet-facing surfaces, for example felt liners, to reduce abrasion and surface damage while maintaining the mechanical restraint provided by the beams. The intermediate restraint beams 510 can be arranged along one side of the frame or along multiple sides of the frame, depending on cabinet geometry, expected shock directions, and desired restraint stiffness. The arrangement illustrated in FIG. 5 is an example and does not limit the present disclosure.

FIG. 5 further illustrates cushioning material 520 disposed at the height of the intermediate restraint beams 510 and positioned between an inner side of the frame and a side surface of the equipment cabinet. In some embodiments, the cushioning material 520 comprises EPE and is sized and located to fill a local clearance region at the intermediate restraint region, thereby providing compliant contact and impact buffering at the center-of-gravity region of the equipment cabinet. In this configuration, the cushioning material 520 is used as a gap filler and soft protective interface that cooperates with the intermediate restraint beams 510, for example by reducing abrasion and distributing contact loads while the intermediate restraint beams 510 provide mechanical restraint. The combination of the intermediate restraint beams 510 and the cushioning material 520 at the intermediate restraint region improves stability of the equipment cabinet during transport and reduces the likelihood of cabinet shifting, rocking, or tipping relative to the base platform, while also mitigating localized impact and surface damage at cabinet contact areas.

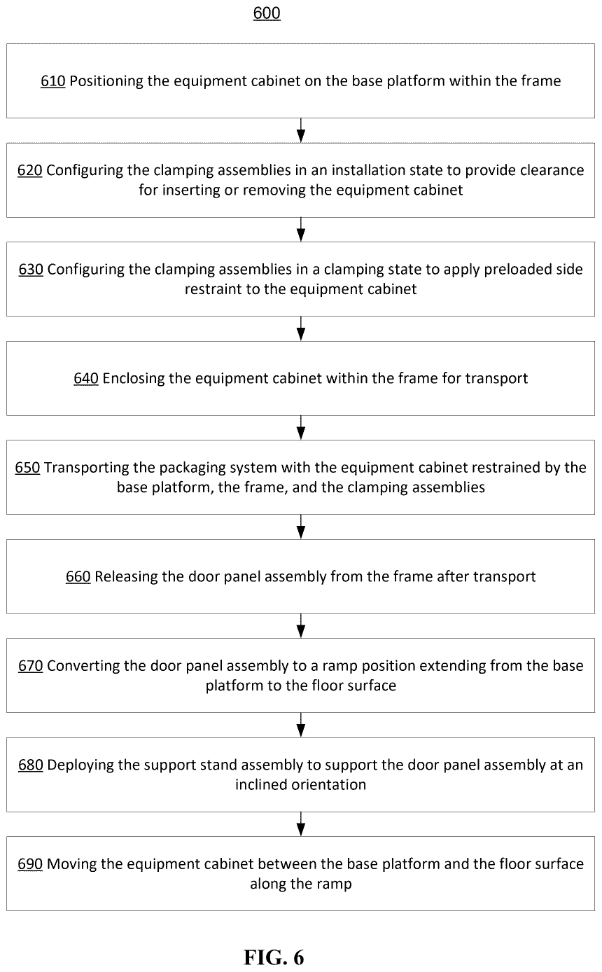

FIG. 6 illustrates an example method of using the packaging system with preloaded clamping and a convertible door ramp to move an equipment cabinet between a base platform and a floor surface, in accordance with some embodiments. Although described as a sequence of steps, one or more steps may be omitted, reordered, repeated, or performed in parallel, depending on site conditions, available handling equipment, and cabinet configuration.

Step 610 includes positioning the equipment cabinet on the base platform within the frame. In some embodiments, the packaging system is prepared in an installation configuration in which one or more door panels and/or side panels are removed or opened to provide access to an interior region of the frame. The equipment cabinet is then moved onto the base platform and into the frame, for example by rolling the equipment cabinet into the frame on cabinet wheels or casters, or by using handling equipment to place the equipment cabinet on the base platform. In some embodiments, the equipment cabinet is guided so that a lower portion of the equipment cabinet is received within a lower restraint region defined by the frame and the clamping assemblies and, where provided, lower restraint beams disposed on an inner side of the frame around the lower portion of the equipment cabinet. In some embodiments, the equipment cabinet is positioned such that side surfaces of the equipment cabinet are aligned with corresponding clamping assemblies mounted to the frame.

Step 620 includes configuring the clamping assemblies in an installation state to provide clearance for inserting or removing the equipment cabinet. In some embodiments, prior to inserting the equipment cabinet, one or more adjustment fasteners of each clamping assembly are tightened to compress an elastomeric block and draw a contact pad toward the frame, thereby increasing a clearance between the contact pad and the equipment cabinet footprint region. In some embodiments, this installation state reduces interference between the contact pads and the equipment cabinet during insertion and reduces the risk of scraping or snagging.

Step 630 includes configuring the clamping assemblies in a clamping state to apply preloaded side restraint to the equipment cabinet. In some embodiments, after the equipment cabinet is in place, the one or more adjustment fasteners of each clamping assembly are loosened to reduce compression of the elastomeric block and allow the elastomeric block to expand, thereby urging the contact pad into clamping engagement with a corresponding side surface of the equipment cabinet. In some embodiments, the adjustment fasteners are loosened by a controlled amount such that the elastomeric block remains partially compressed and maintains a preload that continues to apply clamping force during transport while allowing limited compliance to absorb vibration and reduce peak impact transmission.

Step 640 includes enclosing the equipment cabinet within the frame for transport. In some embodiments, one or more side panels are installed on corresponding side portions of the frame. In some embodiments, the door panel assembly is installed in a closed position in which the door panel assembly is oriented substantially vertically and forms at least part of a side wall of the frame that surrounds the equipment cabinet. In some embodiments, at least one latch releasably secures the door panel assembly to the frame in the closed position. In some embodiments, the door panel assembly comprises an inner side that faces toward the equipment cabinet and an outer side that faces away from the equipment cabinet when the door panel assembly is in the closed position, and a support stand assembly is attached to the inner side such that the support stand assembly is stowed within the frame during transport.

Step 650 includes transporting the packaging system with the equipment cabinet restrained by the base platform, the frame, and the clamping assemblies. In some embodiments, the base platform supports the equipment cabinet and provides vibration reduction and impact buffering, while the clamping assemblies and any lower and intermediate restraint regions limit lateral movement and reduce rocking or tipping tendencies of the equipment cabinet relative to the base platform during transport.

Step 660 includes releasing the door panel assembly from the frame after transport. In some embodiments, at least one latch is released to detach the door panel assembly from the frame. In some embodiments, the door panel assembly is removed by a user grasping one or more door panel handles accessible from outside the frame when the door panel assembly is in the closed position. In some embodiments, the door panel assembly comprises multiple pieces, including a lower door panel and an upper door panel, and each piece is removed individually to reduce the manual handling burden.

Step 670 includes converting the door panel assembly to a ramp position extending from the base platform to the floor surface. In some embodiments, the door panel assembly is positioned such that one edge is supported by the base platform and an opposite edge rests on the floor surface, and at least part of the door panel assembly extends downward from the base platform toward the floor surface to define a ramp configured to guide movement of the equipment cabinet between the base platform and the floor surface. In some embodiments, the outer side of the door panel assembly that faces away from the equipment cabinet in the closed position is oriented upward in the ramp position and defines a ramp surface extending from an edge adjacent the base platform toward a remote edge of the door panel assembly. In some embodiments, the ramp surface includes movement-resisting features arranged along a length of the ramp surface and configured to resist movement of the equipment cabinet along the ramp surface, and the ramp surface further includes raised side edges extending along opposite lateral sides of the ramp surface to guide cabinet motion.

Step 680 includes deploying the support stand assembly to support the door panel assembly at an inclined orientation. In some embodiments, the support stand assembly is attached to the inner side of the door panel assembly when the door panel assembly is in the closed position and is stowed within the frame during transport. When the door panel assembly is placed in the ramp position, the support stand assembly is deployed such that at least one support stand rests on the floor surface and supports the door panel assembly at the inclined orientation relative to the floor surface. In some embodiments, the support stand assembly includes at least one support stand having a generally triangular profile in a side view, with a first side fixed to the inner side of the door panel assembly and a second side resting on the floor surface, thereby forming a stable support structure under the ramp.

Step 690 includes moving the equipment cabinet between the base platform and the floor surface along the ramp. In some embodiments, the equipment cabinet is rolled down the ramp from the base platform to the floor surface, or rolled up the ramp from the floor surface to the base platform, depending on installation direction. The movement-resisting features provide mechanical resistance that reduces acceleration and enables stepwise control of cabinet motion, and the raised side edges guide the cabinet to reduce lateral drift. In some embodiments, after the equipment cabinet is positioned on the floor surface, one or more clamping assemblies are optionally returned to the installation state by tightening the adjustment fasteners to increase clearance and facilitate removal of the equipment cabinet from the frame, and one or more panels of the packaging system are removed to provide access for cabinet extraction.

As shown, the packaging system described herein provides technical improvements in both transport stability and unloading safety for heavy equipment. In particular, the packaging system can (i) actively change the restraint geometry between a loading configuration and a shipping configuration using elastomer preload, (ii) apply restraint at a center-of-gravity region to suppress rocking, and (iii) use an inner-stowed support stand for a convertible ramp plus integrated movement-resistance to mechanically control cabinet motion during unloading.

As an example, the clamping assemblies (e.g., clamping assemblies 130) provide a controllable preload restraint mechanism that improves usability while maintaining robust lateral restraint during shipment. For example, during loading or unloading, one or more fasteners (e.g., nuts and bolts 132) can be tightened to compress an elastomeric block (e.g., elastomeric block 134) and retract a cabinet-contacting interface (e.g., contact pad 136) toward a mounting portion of the frame (e.g., frame 120), thereby increasing clearance and reducing interference while the equipment is inserted into or removed from the frame. After the equipment is received in the frame, the one or more fasteners can be loosened to reduce compression of the elastomeric block, allowing the elastomeric block to expand toward the equipment and urge the cabinet-contacting interface into clamping engagement with a corresponding side surface of the equipment. In this configuration, the elastomeric block provides a sustained preload that maintains contact pressure even in the presence of vibration, impact, thermal variation, or tolerance stack-up, thereby reducing lateral shifting and transport rattle while also providing compliant energy absorption that reduces peak shock transfer into the equipment.

In some embodiments, the packaging system provides targeted multi-level restraint that reduces rocking and tipping tendencies of a tall, heavy cabinet by constraining motion at a lower portion of the equipment and at a height corresponding to a center-of-gravity region of the equipment. For example, a lower restraint region can include one or more lower restraint beams (e.g., lower restraint beams 430) fixed relative to the base platform (e.g., base platform 110) and positioned to engage a lower portion of the equipment to limit lateral movement at the base. However, under lateral transport shocks, restraining the base alone may not sufficiently suppress rocking modes driven by inertia at mid-height. Accordingly, in some embodiments, an intermediate restraint region is provided at a height above the base platform corresponding to the center-of-gravity region of the equipment, and includes one or more intermediate restraint beams (e.g., intermediate restraint beams 510) fixed relative to the frame and positioned to engage the equipment at the height. The intermediate restraint region reduces rocking and tipping by providing an additional restraint plane closer to the center of mass, thereby reducing the effective moment arm that would otherwise amplify rotation about the base during lateral shocks. In some embodiments, cushioning material (e.g., cushioning material 520) is disposed at the intermediate restraint region to fill local clearances and provide compliant buffering at cabinet contact interfaces, while the intermediate restraint beams provide the primary mechanical stop, thereby mitigating abrasion and localized impact without sacrificing positional restraint.

In some embodiments, the packaging system further improves unloading safety and transport robustness by providing a panel assembly (e.g., door panel assembly 140) that is movable between a closed position covering an opening of the frame and a ramp position defining a ramp for guiding movement of the equipment between the base platform and the floor surface. In some embodiments, a support stand assembly (e.g., support stand assembly 160) is coupled to an inner side of the panel assembly facing toward the equipment, such that the support stand assembly is stowed within the frame when the panel assembly is in the closed position. This inner-side arrangement reduces exposure of the support stand assembly to impacts, snagging, and deformation during transport as compared with support structures mounted on an outer side of a door panel. When unloading is desired, the panel assembly can be repositioned to the ramp position and supported at an inclined orientation relative to the floor surface by the support stand assembly. In some embodiments, the outer side of the panel assembly defines a ramp surface that includes movement-resisting features (e.g., transverse ribs) arranged along a length of the ramp surface and configured to resist motion of the equipment along the ramp surface, thereby providing inherent speed moderation for heavy equipment during descent and reducing reliance on operator strength to control acceleration. In some embodiments, raised side edges along the ramp surface guide cabinet travel and reduce lateral drift, further reducing the likelihood of tip-over events during movement between the base platform and the floor surface.

Collectively, these structural and operational features provide a coordinated packaging approach that improves transport stability by maintaining controlled, compliant restraint contact under shock and vibration, reduces rocking and tipping by restraining the equipment near its center-of-gravity region, and improves unloading safety by providing a protected, supported ramp with integrated movement control features.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A packaging system for transporting equipment, comprising:
a base platform, configured to support the equipment;
a frame coupled to the base platform, configured to surround the equipment; and
a plurality of clamping assemblies mounted to the frame and configured to be positioned adjacent to side surfaces of the equipment,
wherein each of the plurality of clamping assemblies comprises:
an elastomeric block configured to engage a corresponding side surface of the equipment,
one or more fasteners extending through the frame and configured, when tightened, to compress the elastomeric block to increase clearance for inserting or removing the equipment, and, when loosened, to allow the elastomeric block to expand toward the corresponding side surface of equipment when the equipment is received in the frame.

2. The packaging system of claim 1, wherein the elastomeric block comprises a first side facing the frame at a mounting portion on which the clamping assembly is mounted and a second side facing away from the mounting portion of the frame on which the clamping assembly is mounted, and
each of the plurality of clamping assemblies further comprises:
a contact pad coupled to the second side of the elastomeric block, and the elastomeric block is configured to engage the corresponding side of the equipment via the contact pad.

3. The packaging system of claim 2, wherein each of the plurality of clamping assemblies is configurable to be in an installation state in which the one or more fasteners are tightened to compress the elastomeric block and pull the contact pad toward the mounting portion of the frame on which the clamping assembly is mounted, increasing a clearance for inserting or removing the equipment.

4. The packaging system of claim 2, wherein each of the plurality of clamping assemblies is configurable to be in a clamping state in which, after the equipment is in place, the one or more fasteners are loosened to reduce compression of the elastomeric block and allow the elastomeric block to expand and urge the contact pad into clamping engagement with the corresponding side surface of the equipment.

5. The packaging system of claim 1, wherein the frame and the plurality of clamping assemblies together define a lower restraint region fixed relative to the base platform and positioned to engage a lower portion of the equipment to limit lateral movement of the lower portion of the equipment.

6. The packaging system of claim 1, wherein
the packaging system further comprises:
an intermediate restraint region fixed relative to the frame at a height corresponding to a center of gravity region of the equipment and positioned to engage the equipment at the height so as to limit rocking or tipping of the equipment relative to the base platform.

7. The packaging system of claim 6, wherein the intermediate restraint region comprises at least one elongated restraint beam disposed on an inner side of the frame and extending along at least one side of the frame at the height above the base platform.

8. The packaging system of claim 7, wherein the at least one elongated restraint beam is fastened to the frame by a plurality of brackets.

9. The packaging system of claim 5, wherein the lower restraint region further comprises:
at least two lower restraint beams fixed relative to the base platform and disposed on an inner side of the frame.

10. The packaging system of claim 1, wherein the plurality of clamping assemblies comprises at least two clamping assemblies including at least one clamping assembly mounted on a first side portion of the frame and at least one clamping assembly mounted on an opposing second side portion of the frame.

11. The packaging system of claim 1, wherein the base platform comprises:
a lower layer;
a lower metal plate disposed above the lower layer;
a plurality of elastomeric support blocks disposed above the lower metal plate;
an upper metal plate disposed above the plurality of elastomeric support blocks; and
an upper layer disposed above the upper metal plate.

12. A packaging system for transporting equipment, comprising:
a base platform; and
a frame coupled to the base platform and configured to surround the equipment, wherein the frame comprises:
a panel assembly movable between:
a closed position in which the panel assembly is positioned to cover an opening of the frame, wherein the panel assembly comprises an inner side facing toward the equipment and an outer side facing away from the equipment, and
a ramp position in which at least a portion of the panel assembly defines a ramp configured to guide movement of the equipment between the base platform and a floor surface; and
a support stand assembly coupled to the inner side of the panel assembly facing toward the equipment and configured to support the panel assembly when defining the ramp.

13. The packaging system of claim 12, wherein when the panel assembly is in the ramp position, the panel assembly is configured to be in an inclined orientation relative to the floor surface and supported by the support stand assembly.

14. The packaging system of claim 12, wherein:
the outer side of the panel assembly comprises a ramp surface,
the ramp surface comprising movement-resisting features configured to resist movement of the equipment along the ramp surface.

15. The packaging system of claim 12, wherein the panel assembly comprises:
a lower door panel and an upper door panel, and wherein, in the closed position, the lower door panel and the upper door panel together form a continuous side wall of the frame.

16. The packaging system of claim 15, wherein each of the lower door panel and the upper door panel comprises at least one handle accessible from outside the frame in the closed position to facilitate manual handling of the respective door panel.

17. The packaging system of claim 12, further comprising at least one latch configured to releasably secure the panel assembly to the frame in the closed position.

18. The packaging system of claim 12, wherein the support stand assembly comprises at least one support stand having a generally triangular profile in a side view, the at least one support stand having a first side fixed to the inner side of the panel assembly and a second side configured to rest on the floor surface when the panel assembly is in the ramp position.

19. The packaging system of claim 12, wherein the ramp surface further comprises raised side edges extending along opposite lateral sides of the ramp surface and configured to guide the movement of the equipment along the ramp surface.

20. The packaging system of claim 14, wherein the movement-resisting features comprise a plurality of transverse ribs extending across the ramp surface between raised side edges.
